(19) United States
(12) Patent Application Publication
(10) Pub. No.: US 2022/0049725 A1
(43) Pub. Date: Feb. 17, 2022

(54) FLUID PRESSURE CYLINDER

(71) Applicant: SMC CORPORATION, Chiyoda-ku (JP)

(72) Inventor: Tsuyoshi ASABA, Abiko-shi (JP)

(73) Assignee: SMC CORPORATION, Chiyoda-ku (JP)

(21) Appl. No.: 17/275,417

(22) PCT Filed: Sep. 9, 2019
(86) PCT No.: PCT/JP2019/035382

§ 371 Date: Mar. 11, 2021

(30) Foreign Application Priority Data
Sep. 12, 2018 (JP) 2018-170597

(51) Int. Cl. F15B 15/14; F15B 15/20; F15B 15/28

(52) U.S. Cl. CPC F15B 15/1409; F15B 15/204; F15B 15/2807; F15B 15/202

(57) ABSTRACT

In a fluid pressure cylinder having a body having a pair of cylinder holes, a pair of pistons movably accommodated respectively in the pair of cylinder holes, a pair of piston rods secured respectively to the pair of pistons, and an end plate connected to end portions of the pair of piston rods, each of the pistons partitions the corresponding cylinder hole into a head-side cylinder chamber and a rod-side cylinder chamber. The body includes a solenoid valve configured to switch between supply of pressurized fluid to the head-side cylinder chambers or the rod-side cylinder chambers and discharge of the pressurized fluid from the head-side cylinder chambers or the rod-side cylinder chambers, and the solenoid valve is disposed inside a surface of the body.

### TECHNICAL FIELD

The present invention relates to fluid pressure cylinders moving pistons based on supply and discharge of pressurized fluid.

### BACKGROUND ART

A known fluid pressure cylinder includes a cylinder tube with a cylinder hole, a piston accommodated in the cylinder hole to be movable, a piston rod secured to the piston, and an end plate connected to an end portion of the piston rod (see Japanese Laid-Open Patent Publication No. 09-303318). The fluid pressure cylinder moves the piston, the piston rod, and the end plate forward by pressurized fluid being supplied to a head-side cylinder chamber in the cylinder tube and discharged from a rod-side cylinder chamber in the cylinder tube. Conversely, the fluid pressure cylinder moves the piston, the piston rod, and the end plate backward by pressurized fluid being supplied to the rod-side cylinder chamber and discharged from the head-side cylinder chamber.

### SUMMARY OF INVENTION

The fluid pressure cylinder of this type switches between supply and discharge of pressurized fluid to and from the rod-side cylinder chamber or the head-side cylinder chamber based on the operation of a solenoid valve connected to the fluid pressure cylinder during actual use. For example, in the fluid pressure cylinder disclosed in Japanese Laid-Open Patent Publication No. 09-303318, a solenoid valve and a sub-base configured to switch flow channels for pressurized fluid and to which the solenoid valve is connected are attached to a surface (side surface) of the cylinder tube.

Since the solenoid valve and other elements are attached to the surface of the cylinder tube, the size of the fluid pressure cylinder becomes larger during actual use compared with the size when the fluid pressure cylinder is provided as a product. Thus, users may have difficulties in securing an installation space for the fluid pressure cylinder while taking into consideration the positional relationship with other devices. Moreover, many hours are required to attach the solenoid valve and other elements to the fluid pressure cylinder.

The present invention has been devised taking into consideration the aforementioned problems, and has the object of providing a fluid pressure cylinder capable of achieving significant space-saving and improved usability during use with a simple structure.

To achieve the above-described object, a fluid pressure cylinder according to an aspect of the present invention includes a body having a pair of cylinder holes, a pair of pistons movably accommodated respectively in the pair of cylinder holes, a pair of piston rods secured respectively to the pair of pistons, and an end plate connected to end portions of the pair of piston rods, wherein each of the pistons partitions the corresponding cylinder hole into a head-side cylinder chamber and a rod-side cylinder chamber, wherein the body includes a solenoid valve configured to switch between supply of pressurized fluid to the head-side cylinder chambers or the rod-side cylinder chambers and discharge of the pressurized fluid from the head-side cylinder chambers or the rod-side cylinder chambers, and wherein the solenoid valve is disposed inside a surface of the body.

The fluid pressure cylinder includes the solenoid valve switching between supply and discharge of pressurized fluid to and from the head-side cylinder chambers or the rod-side cylinder chambers. Thus, the solenoid valve is not required to be added separately for actual use of the fluid pressure cylinder. Moreover, the solenoid valve is disposed inside the surfaces of the body. Thus, the fluid pressure cylinder does not increase in size as an entire system during actual use, thereby allowing users to, for example, carry out design for installation in a preferred manner. That is, the fluid pressure cylinder can achieve significant space-saving and improved usability during use with a simple structure.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF DRAWINGS

FIG. 1 is a perspective view of a fluid pressure cylinder according to an embodiment of the present invention;

FIG. 2 is a view of the fluid pressure cylinder as viewed from a base end side;

FIG. 3 is a cross-sectional view taken along line III-III in FIG. 2;

FIG. 4 is a cross-sectional view taken along line IV-IV in FIG. 2;

FIG. 5 is a cross-sectional view taken along line V-V in FIG. 2; and

FIG. 6A is an explanatory view illustrating flow of pressurized fluid when a spool is disposed at a first position, and FIG. 6B is an explanatory view illustrating flow of the pressurized fluid when the spool is disposed at a second position.

### DESCRIPTION OF EMBODIMENTS

A preferred embodiment according to the present invention will be described in detail below with reference to the accompanying drawings.

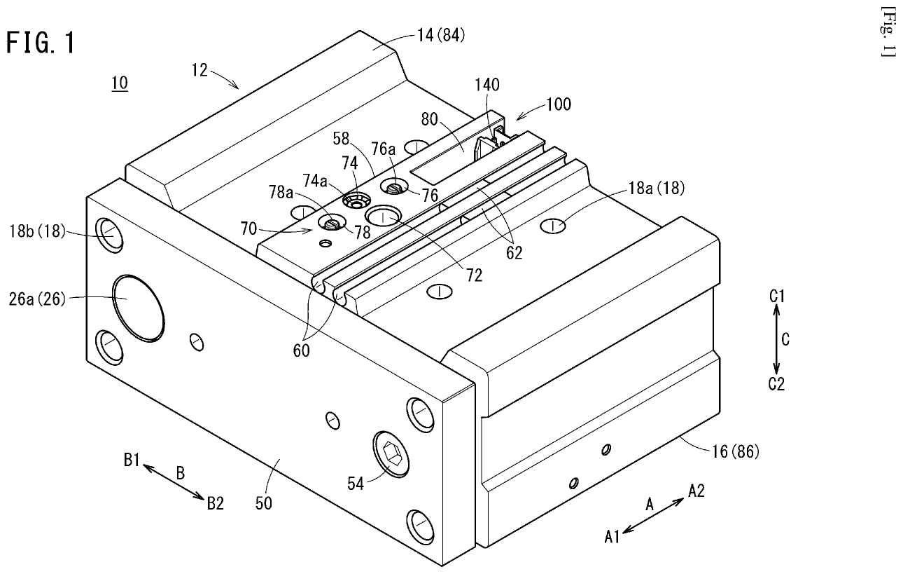

As illustrated in FIG. 1, a fluid pressure cylinder 10 according to an embodiment of the present invention includes a rectangular parallelepiped body 12 with six faces (surfaces). In the description below, based on arrows illustrated in FIG. 1, a direction along which the axis of the body 12 (cylinder axis) extends is also referred to as a direction of an arrow A, the width direction of the body 12 is also referred to as a direction of an arrow B, and the thickness direction of the body 12 is also referred to as a direction of an arrow C.

A face of the body 12 on a side at which an arrow C1 is pointing (hereinafter referred to as “upper surface 14”) and a face thereof on a side at which an arrow C2 is pointing (hereinafter referred to as “lower surface 16”) have rectangular shapes when viewed in plan. The body 12 has a plurality of fastener holes 18 for securing the fluid pressure cylinder 10 to a chosen object (installation target). The fastener holes 18 include four holes 18a passing through the body 12 from the upper surface 14 to the lower surface 16 and four holes 18b passing through the body 12 (including an end plate 50 described below) in the axial direction. The fastener holes 18 may have a female thread portion for thereby screwing the body 12 to the object.

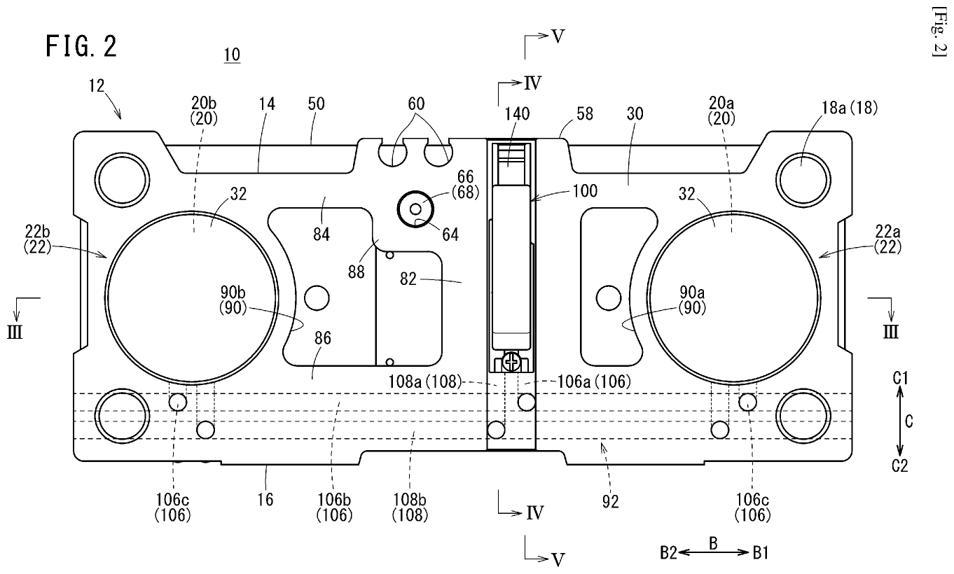

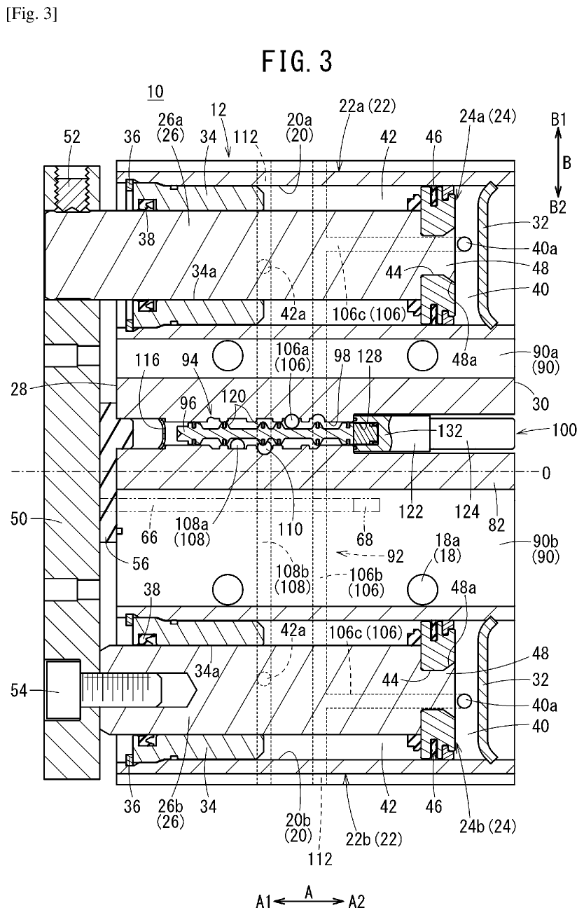

As illustrated in FIGS. 2 and 3, the body 12 includes a pair of (two; one set of) cylinder tubes 22 each having a cylinder hole 20 formed therein. The pair of cylinder tubes 22 are disposed respectively at one end and another end of the body 12 in the direction of the arrow B (longitudinal direction of the body 12 when viewed in plan). In the description below, the cylinder tube 22 on a side at which an arrow B1 is pointing is also referred to as a first cylinder tube 22a, and the cylinder tube 22 on a side at which an arrow B2 is pointing is also referred to as a second cylinder tube 22b. The first cylinder tube 22a has a first cylinder hole 20a formed therein, and the second cylinder tube 22b has a second cylinder hole 20b formed therein.

The first and second cylinder tubes 22a and 22b are arranged side by side such that the axes of the first and second cylinder holes 20a and 20b extend in the direction of the arrow A (parallel to each other). A piston 24 (a first piston 24a and a second piston 24b) and a piston rod 26 (a first piston rod 26a and a second piston rod 26b) secured to the piston 24 are displaceably accommodated in each of the first and second cylinder holes 20a and 20b. The structure of the first cylinder tube 22a (including the first piston 24a and the first piston rod 26a) is basically identical to the structure of the second cylinder tube 22b (including the second piston 24b and the second piston rod 26b). In the description below, the first cylinder tube 22a will be described as a representative example, and the description of the second cylinder tube 22b will be omitted.

The first cylinder hole 20a passes through a face of the body 12 on a side at which an arrow Al is pointing (hereinafter referred to as “distal end surface 28”) and a face on a side at which an arrow A2 is pointing (hereinafter referred to as “base end surface 30”). The first cylinder tube 22a includes a head cover 32 on an inner circumferential surface of the first cylinder hole 20a at the base end side. The head cover 32 airtightly closes the base end of the first cylinder hole 20a.

The first cylinder tube 22a includes a rod cover 34 on an inner circumferential surface of the first cylinder hole 20a at the distal end side. The rod cover 34 has a cylindrical shape and is secured to the inner circumferential surface of the first cylinder hole 20a. The rod cover 34 has therein a through-hole 34a through which the first piston rod 26a passes. The rod cover 34 prevents the first piston 24a from coming off the first cylinder hole 20a and, at the same time, allows part of the first piston rod 26a to be exposed from the first cylinder hole 20a to the outside of the first cylinder tube 22a (distal end side) via the through-hole 34a. The rod cover 34 is inserted into the distal end of the first cylinder hole 20a, and a locking ring 36 is then inserted at the distal end side of the rod cover 34 to thereby prevent the rod cover 34 from coming off.

A seal member 38 is disposed on the inner circumferential surface of the rod cover 34 defining the through-hole 34a. The seal member 38 is in airtight contact with the outer circumferential surface of the first piston rod 26a. The first piston rod 26a is displaced in the direction of the arrow A inside the first cylinder hole 20a while the seal member 38 prevents pressurized fluid inside the first cylinder hole 20a from flowing out.

The first piston 24a disposed inside the first cylinder hole 20a partitions the first cylinder hole 20a into two spaces. More specifically, the space adjacent to the base end of the first piston 24a is defined as a head-side cylinder chamber 40, and the space adjacent to the distal end of the first piston 24a is defined as a rod-side cylinder chamber 42.

The head-side cylinder chamber 40 is enclosed by the first piston 24a, the distal end surface of the head cover 32, and the inner circumferential surface of the first cylinder tube 22a defining the first cylinder hole 20a. A head-side opening 40a through which pressurized fluid flows in and out is formed in the inner circumferential surface of the head-side cylinder chamber 40 at a predetermined position (on the side at which the arrow C2 is pointing and adjacent to the head cover 32). The rod-side cylinder chamber 42 is enclosed by the first piston 24a, the base end surface of the rod cover 34, and the inner circumferential surface of the first cylinder tube 22a. A rod-side opening 42a through which pressurized fluid flows in and out is formed in the inner circumferential surface of the rod-side cylinder chamber 42 at a predetermined position (on the side at which the arrow C2 is pointing and adjacent to the rod cover 34).

The first piston 24a is slidable on the inner circumferential surface of the first cylinder tube 22a while airtightly isolating the head-side cylinder chamber 40 and the rod-side cylinder chamber 42 from each other. The first piston 24a has a disk shape with a sufficient thickness extending in the direction of the arrow A. The first piston 24a has a connection hole 44 in the central part, and a base end portion of the first piston rod 26a is inserted into the connection hole 44.

An annular piston packing 46 composed of an elastic material is attached on the outer circumferential surface of the first piston 24a. The piston packing 46 is in contact with the inner circumferential surface of the first cylinder tube 22a in the circumferential direction and thereby airtightly separates the head-side cylinder chamber 40 and the rod-side cylinder chamber 42 from each other.

The first piston rod 26a is a sold cylindrical member extending along the axis of the first cylinder hole 20a (direction of the arrow A) to a predetermined length (greater than the total length of the first cylinder hole 20a). The total length of the second piston rod 26b is slightly less than the total length of the first piston rod 26a.

The first piston rod 26a includes an attachment part 48 at the base end portion. The diameter of the attachment part 48 is less than the diameter of the extending part (i.e., main part) of the first piston rod 26a. The attachment part 48 includes a flange 48a at the base end. The attachment part 48 is tightly inserted into the connection hole 44 of the first piston 24a, and the flange 48a is caught by the base end edge of the first piston 24a, whereby the first piston rod is firmly secured to the first piston 24a.

A distal end portion of the first piston rod 26a protrudes toward the distal end side from the first cylinder tube 22a through the through-hole 34a of the rod cover 34. The end plate 50 is secured to the distal end portion. During use of the fluid pressure cylinder 10, a plate (not illustrated) is attached to the end plate 50, and a workpiece disposed on the plate is displaced under action of the pistons 24.

The end plate 50 is a block with a predetermined thickness in the direction of the arrow A, and has a rectangular shape with long sides extending in the direction of the arrow B and short sides extending in the direction of the arrow C when the fluid pressure cylinder 10 is viewed from front. The end surfaces (the distal end surface and the base end surface) of the end plate 50 have substantially the same size as the distal end surface 28 of the body 12. The holes 18a described above are created at positions adjacent to the four corners of the end plate 50.

While the distal end of the first piston rod 26a is inserted into the end plate 50, a fastener 52 is inserted into the end plate 50 from the side at which the arrow B1 is pointing, to thereby press the outer circumferential surface of the first piston rod 26a. This causes part of the end plate 50 on the arrow B1 side to be joined to the first piston rod 26a. On the other hand, while the distal end of the second piston rod 26b is in contact with the base end surface of the end plate 50, a fixing screw 54 is inserted and screwed into the end plate 50 from the distal end side to thereby join part of the end plate 50 on the arrow B2 side to the second piston rod 26b.

Furthermore, the fluid pressure cylinder 10 includes an elastic body 56 on the distal end surface 28 in the middle of the body 12 in the width direction. The elastic body 56 is interposed between the body 12 and the end plate 50 to define the stroke end of the end plate 50 in backward movement and has a function of absorbing impact in backward movement of the end plate 50.

Returning to FIG. 1, the fluid pressure cylinder 10 includes a middle protrusion 58 on top of the body 12 in the middle in the width direction. A pair of sensor attachment grooves 60 are formed in the upper surface 14 at part of the middle protrusion 58 on the arrow B2 side. For example, the sensor attachment grooves 60 recessed from the upper surface of the middle protrusion 58 have a substantially semicircular cross-section and extend along the axis (direction of the arrow A) in a straight line. The sensor attachment grooves 60 each hold a detection sensor 62 detecting the moving position of the pistons 24.

A bar hole 64 is formed in a portion (expanding portion 88; described below) below the sensor attachment grooves 60 (see FIG. 2). A rod 66 having a circular cross-section and extending in the direction of the arrow A in a straight line (parallel to the piston rods 26) is movably accommodated in the bar hole 64. The rod 66 penetrates through the elastic body 56 (see FIG. 3) and is exposed to the outside. The end plate 50 is connected to a distal end of the rod 66, and a magnet 68 is attached to a base end thereof. The magnet 68 is an object to be detected by the detection sensors 62. That is, the detection sensors 62 detect the magnetism of the magnet 68 to detect the axial position of the end plate 50 (in other words, the pistons 24) while the rod 66 moves in the axial direction.

A port group 70 (a supply port 72, a discharge port 74, and two controller ports 76 and 78) and a solenoid valve accommodation space 80 are formed in part of the upper surface 14 of the middle protrusion 58 on the arrow B1 side. The supply port 72 is used to supply pressurized fluid into the body 12, and the discharge port 74 is used to discharge the pressurized fluid from the body 12. When the body 12 is viewed in plan, the supply port 72 and the discharge port 74 are aligned in the direction of the arrow B of the body 12. Moreover, the discharge port 74 is disposed between the two controller ports 76 and 78, and the three ports 74, 76, and 78 are approximately aligned in the direction of the arrow A of the body 12.

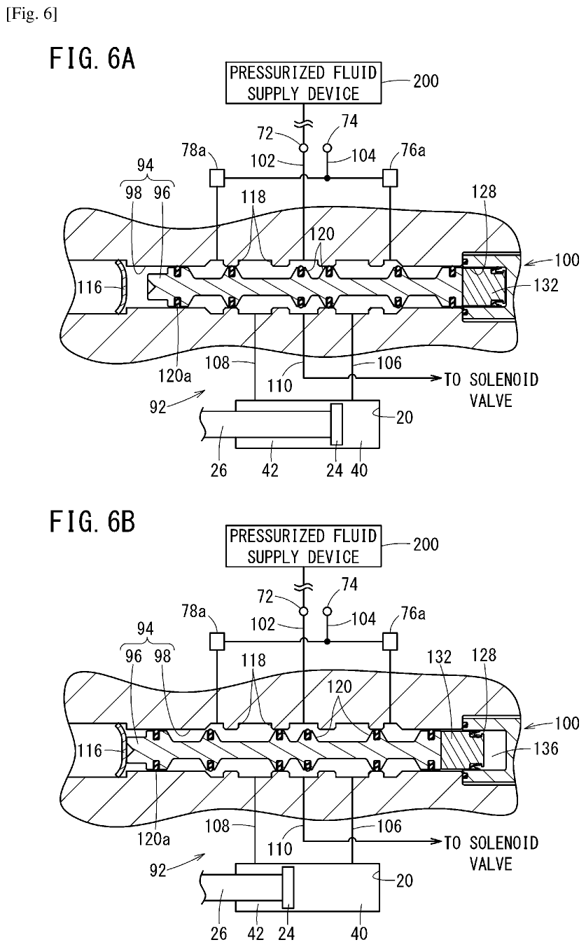

A joint (not illustrated) is inserted into and secured to the supply port 72 during use of the fluid pressure cylinder 10. The joint is connected to a pressurized fluid supply device 200 (see FIG. 6A) to allow pressurized fluid supplied from the pressurized fluid supply device 200 to flow into the supply port 72. A silencer 74a is inserted into the discharge port 74 in advance to reduce the discharge noise of the pressurized fluid. Moreover, a head-side speed controller 76a is inserted into the base-end-side controller port 76, and a rod-side speed controller 78a is inserted into the distal-end-side controller port 78.

As illustrated in FIGS. 2 to 5, the fluid pressure cylinder 10 according to this embodiment includes a middle block portion 82 at a position overlapping with the port group 70. The middle block portion 82 extends vertically between an upper wall 84 (first wall portion which lies on one end side in the thickness direction) constituting the upper surface 14 of the body 12 and a lower wall 86 (second wall portion which lies on another end side in the thickness direction) constituting the lower surface 16 of the body 12. The middle block portion 82 as a whole is disposed closer to the first cylinder tube 22a (i.e., on the side at which the arrow B1 is pointing) with respect to the centerline O in the width direction of the body 12. The middle block portion 82 has the expanding portion 88 at a position closer to the upper wall 84. The bar hole 64 is formed in the expanding portion 88 according to the installation of, for example, the above-described detection sensors 62.

In the body 12, lightening portions 90 (a first lightening portion 90a and a second lightening portion 90b) are formed between the first cylinder tube 22a and the middle block portion 82 and between the second cylinder tube 22b and the middle block portion 82. For example, the lightening portions 90 are formed so as to pass through the entire body 12 from the distal end surface 28 to the base end surface 30. Since the middle block portion 82 is offset from the centerline O in the width direction, the narrower first lightening portion 90a is formed between the middle block portion and the first cylinder tube 22a, and the wider second lightening portion 90b is formed between the middle block portion and the second cylinder tube 22b.

A mechanism for supplying and discharging pressurized fluid to and from the head-side cylinder chambers 40 and the rod-side cylinder chambers 42 of the above-described first and second cylinder tubes 22a and 22b is provided inside the middle block portion 82 and in the upper wall 84 and the lower wall 86 of the body 12.

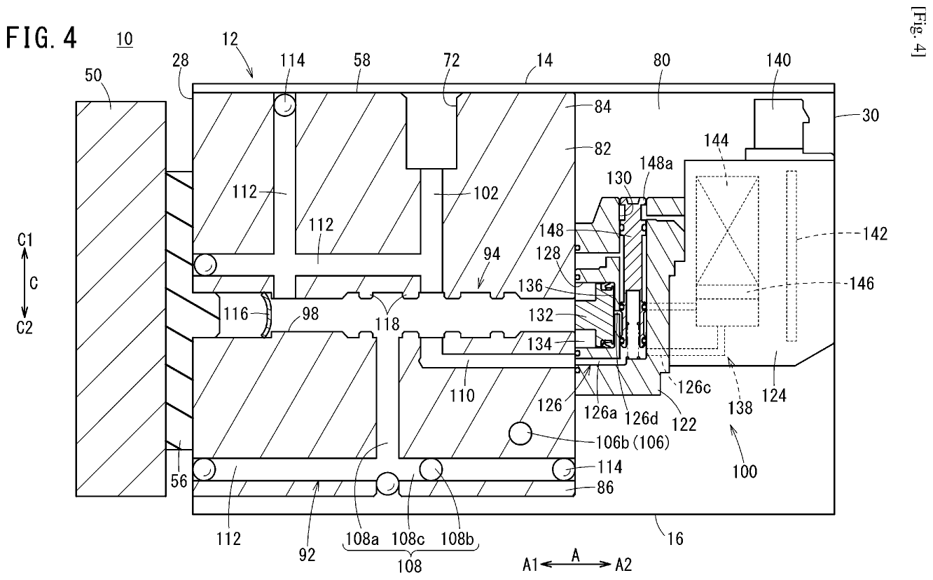

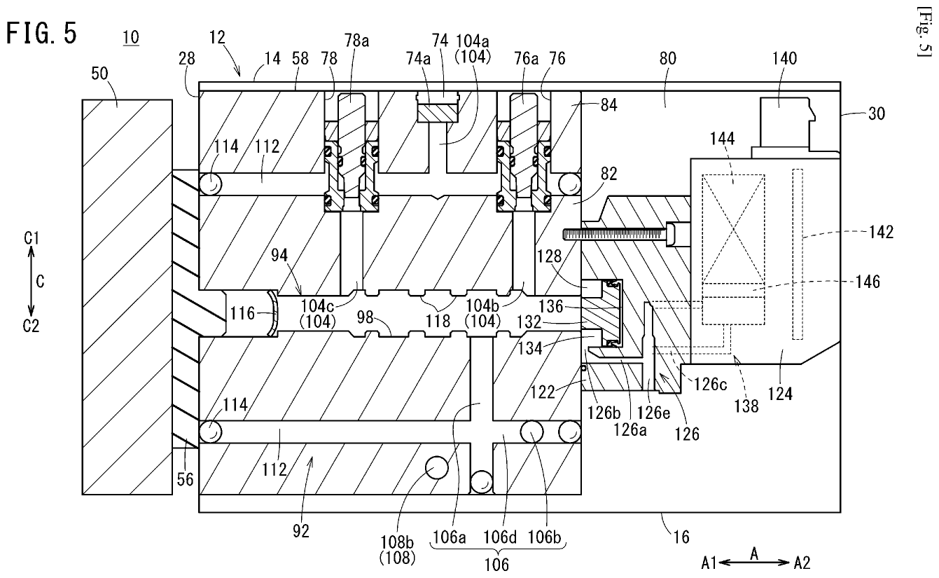

Specifically, the middle block portion 82, the upper wall 84, and the lower wall 86 are provided with channels (flow channels) 92 through which pressurized fluid flows. Furthermore, a channel selector 94 configured to switch the channels 92 through which the pressurized fluid flows is provided inside the middle block portion 82. The channel selector 94 includes a spool 96 and a spool accommodation space 98. The spool 96 is movably accommodated in the spool accommodation space 98, and the channels 92 communicate with the spool accommodation space 98. As illustrated in FIGS. 4 and 5, the spool accommodation space 98 is formed in a middle part of the body 12 in the thickness direction. In FIGS. 4 and 5, the spool 96 is not illustrated to facilitate under-standing of the figures.

The solenoid valve accommodation space 80 is sized to accommodate a solenoid valve 100 by cutting out a part adjacent to the base end of the channels 92 and the spool accommodation space 98 from the middle block portion 82. In this embodiment, the solenoid valve accommodation space 80 has openings to the outside, at the upper surface 14, the lower surface 16, and the base end surface 30 of the body 12. The solenoid valve accommodation space 80 may be a closed space in the body 12 (a state where the solenoid valve 100 is partially or entirely non-exposed).

The channels 92 allow pressurized fluid to flow between the port group 70 and the head-side cylinder chambers 40 of the first and second cylinder tubes 22a and 22b and between the port group 70 and the rod-side cylinder chambers 42 of the first and second cylinder tubes 22a and 22b. The channels 92 are configured to cause the pressurized fluid to flow between the port group 70 and the head-side cylinder chambers 40 and between the port group 70 and the rod-side cylinder chambers 42 via the spool accommodation space 98. To achieve this, the channels 92 include a supply channel 102 connecting the supply port 72 with the spool accommodation space 98, and a discharge channel 104 connecting the discharge port 74 with the spool accommodation space 98, between the upper surface 14 of the body 12 and the spool accommodation space 98.

Furthermore, the discharge channel 104 includes a merging path 104a communicating with the discharge port 74, a head-side discharge path 104b connecting the merging path 104a with the spool accommodation space 98 via the controller port 76, and a rod-side discharge path 104c connecting the merging path 104a with the spool accommodation space 98 via the controller port 78.

The channels 92 between the spool accommodation space 98 and the cylinder holes 20 include a head-side communication channel 106 and a rod-side communication channel 108. The head-side communication channel 106 connects the spool accommodation space 98 and the head-side cylinder chambers 40. The rod-side communication channel 108 connects the spool accommodation space 98 and the rod-side cylinder chambers 42.

The head-side communication channel 106 includes a head-side middle path 106a extending, in the thickness direction, through part of the middle block portion 82 on the side at which the arrow C2 is pointing, a head-side lateral path 106b communicating with the head-side middle path 106a and extending inside the lower wall 86 in the width direction, and head-side longitudinal paths 106c communicating with the head-side lateral path 106b in the lower wall 86 at positions overlapping with the first and second cylinder holes 20a and 20b and extending in the axial direction of the first and second cylinder holes 20a and 20b. Moreover, the head-side middle path 106a and the head-side lateral path 106b communicate with each other via a head-side offset path 106d extending in the lower wall 86 in the axial direction. The ends of the head-side longitudinal paths 106c on the side at which the arrow A2 is pointing bend and extend a short distance in the direction of the arrow Cl to communicate with the head-side openings 40a disposed immediately above.

The rod-side communication channel 108 includes a rod-side middle path 108a extending in the middle block portion 82 in the thickness direction and a rod-side lateral path 108b communicating with the rod-side middle path 108a and extending in the lower wall 86 in the width direction. Moreover, the rod-side middle path 108a and the rod-side lateral path 108b communicate with each other via a rod-side offset path 108c extending in the lower wall 86 in the axial direction. The ends of the rod-side lateral path 108b bend and slightly extend in the direction of the arrow C1 to communicate with the rod-side openings 42a disposed immediately above. Furthermore, the rod-side lateral path 108b is disposed at a lower position than the head-side lateral path 106b and the head-side longitudinal paths 106c (on the side at which the arrow C2 is pointing). This structure enables the head-side communication channel 106 and the rod-side communication channel 108 to be isolated from each other.

Furthermore, the channels 92 include a branch channel 110 (pilot channel) allowing pressurized fluid to flow therethrough toward the solenoid valve accommodation space 80, at a position overlapping with the supply port 72 (supply channel 102) below the spool accommodation space 98. The branch channel 110 extends a short distance in the direction of the arrow C2, then bends by 90°, and extends in the direction of the arrow A2 to reach the solenoid valve accommodation space 80. The branch channel 110 communicates with the inside of the solenoid valve 100 disposed in the solenoid valve accommodation space 80.

The above-described channels 92 are formed by boring holes in the body 12 from the surfaces to the inside during production of the body 12. This leaves forming channels 112 inside the body 12. The forming channels 112 communicate with the channels 92, but pressurized fluid does not flow in the forming channels 112. Openings of the forming channels 112 in the outer surfaces of the body 12 except for the port group 70 are blocked up with steel balls 114 (plugs) to prevent pressurized fluid from flowing from the channels 92 outside the body 12.

The spool accommodation space 98 in the middle block portion 82 is a long, thin hollow extending in the direction of the arrow A, and the above-described channels 92 are connected to the spool accommodation space 98 at appropriately chosen positions. More specifically, the head-side discharge path 104b, the head-side communication channel 106 (head-side middle path 106a), the supply channel 102, the rod-side communication channel 108 (rod-side middle path 108a), and the rod-side discharge path 104c communicate with the spool accommodation space 98 in this order from the base end to the distal end. The spool accommodation space 98 has a larger diameter at positions where the channels 92 are connected and has a smaller diameter at the other positions (that is, the spool accommodation space 98 includes a plurality of inward projections 118). Moreover, a restricting member 116 restricting the movement of the spool 96 toward the distal end is accommodated in a distal end portion of the spool accommodation space 98.

The spool 96 is a solid rod including a plurality of annular projections 120 protruding radially outward from the outer circumferential surface and arranged in the axial direction (direction of the arrow A). Blocking rings 120a are disposed on the outer circumferential surfaces of the annular projections 120 to airtightly block up the spool accommodation space 98 in cooperation with the inward projections 118 (see FIG. 6A).

The spool 96 is displaced in the axial direction of the spool accommodation space 98 (direction of the arrow A) under action of the solenoid valve 100 accommodated in the solenoid valve accommodation space 80. Specifically, the spool 96 is configured to be disposed at a first position adjacent to the base end when the solenoid valve 100 is deenergized and at a second position adjacent to the distal end when the solenoid valve 100 is energized. The plurality of annular projections 120 come into contact with different inward projections 118 in the spool accommodation space 98 as appropriate depending on whether the spool 96 is disposed at the first position or the second position to thereby partially shut off the flow of the pressurized fluid inside the spool accommodation space 98 in cooperation with the inward projections 118.

When the spool 96 is disposed at the first position, the supply channel 102 and the rod-side middle path 108a communicate with each other via the spool accommodation space 98, while the head-side discharge path 104b and the head-side middle path 106a communicate with each other via the spool accommodation space 98. At this moment, one of the inward projections 118 that is closer to the base end than the communication point between the rod-side discharge path 104c and the spool accommodation space 98 come into contact with the corresponding annular projection 120 on the spool 96. This causes the rod-side discharge path 104c to be airtightly isolated from the space through which the supply channel 102 and the rod-side middle path 108a communicate with each other (see also FIG. 6A).

The supply channel 102 and the branch channel 110 remain in communication with each other when the spool 96 is disposed at the first position. That is, part of the pressurized fluid supplied from the supply port 72 also flows into the branch channel 110 through the supply channel 102 and the spool accommodation space 98.

On the other hand, when the spool 96 is disposed at the second position, the supply channel 102 and the head-side middle path 106a communicate with each other via the spool accommodation space 98, while the rod-side discharge path 104c and the rod-side middle path 108a communicate with each other via the spool accommodation space 98. At this moment, one of the inward projections 118 that is closer to the distal end than the communication point between the head-side discharge path 104b and the spool accommodation space 98 come into contact with the corresponding annular projection 120 on the spool 96. This causes the head-side discharge path 104b to be airtightly isolated from the space through which the supply channel 102 and the head-side middle path 106a communicate with each other (see also FIG. 6B). The supply channel 102 and the branch channel 110 remain in communication with each other via the spool accommodation space 98 also when the spool 96 is disposed at the second position.

The solenoid valve 100 is accommodated in the solenoid valve accommodation space 80 and secured to the base end surface of the middle block portion 82. As described above, the solenoid valve moves the spool 96 between the first position and the second position inside the spool accommodation space 98. In this embodiment, a pilot operated solenoid valve capable of saving electric power is used as the solenoid valve 100. However, the structure for moving the spool 96 is not limited to such a pilot operated solenoid valve, and a direct acting solenoid valve, for example, may be used to move the spool 96.

Depending on the size of the fluid pressure cylinder 10, the width of the solenoid valve accommodation space 80 accommodating the solenoid valve 100 may be designed in a range of, for example, 5 to 10 mm. The length of the solenoid valve accommodation space 80 in the direction of the arrow A is designed such that the solenoid valve 100 installed in the solenoid valve accommodation space 80 does not protrude from the base end surface 30 of the body 12. That is, the entire solenoid valve 100 is accommodated inside the solenoid valve accommodation space 80 so as not to protrude from the surfaces (the upper surface 14, the lower surface 16, and the base end surface 30) of the body 12.

The solenoid valve 100 includes a first housing 122 directly connected to the base end surface of the middle block portion 82 and a second housing 124 directly connected to the first housing 122.

A first housing channel 126 into which pressurized fluid flows, a piston accommodation space 128 communicating with the spool accommodation space 98, and a manual operator space 130 disposed adjacent to the base end of the piston accommodation space 128 are formed inside the first housing 122.

A pilot piston 132 is movably disposed inside the piston accommodation space 128. The pilot piston 132 is connected to the base end of the spool 96. A piston packing (not illustrated) that is in airtight contact with the inner circumferential surface defining the piston accommodation space 128 is disposed on the outer circumferential surface of the pilot piston 132. That is, the piston accommodation space 128 is partitioned into a first pressure chamber 134 on the distal end side (i.e., on the spool 96 side) and a second pressure chamber 136 on the base end side by the pilot piston 132 being accommodated therein. The diameters of the pilot piston 132 and the piston accommodation space 128 are set to values sufficiently greater than the diameter of the spool 96 (annular projections 120). Thus, the pressurized fluid flowing into the piston accommodation space 128 applies pressure greater than the pressure applied to the spool 96 in the spool accommodation space 98, to the pilot piston 132.

On the other hand, a second housing channel 138 is formed inside the second housing 124, and a power port 140, a circuit board 142, a coil 144, a movable valve portion 146, and other elements are disposed inside the second housing 124. The power port 140 is located in the solenoid valve accommodation space 80 and at a position closer to the upper surface 14 of the body 12 so as not to protrude from the upper surface 14. The circuit board 142 is electrically connected to a power supply (not illustrated) via the power port 140, and has a function of switching between energization and de-energization of the coil 144 at predetermined timings.

The first housing channel 126 includes a main path 126a communicating with the branch channel 110, a first path 126b extending from the main path 126a and communicating with the first pressure chamber 134 in the piston accommodation space 128, a second path 126c extending from the main path 126a and communicating with the second housing channel 138 via the manual operator space 130, a third path 126d extending from the second housing channel 138 and communicating with the second pressure chamber 136 in the piston accommodation space 128 via the manual operator space 130, and a discharge path 126e extending from the main path 126a and communicating with the outside of the first housing 122 (the solenoid valve accommodation space 80).

On the other hand, the second housing channel 138 connects the second path 126c and the third path 126d. The movable valve portion 146 is disposed at an intermediate position in the second housing channel 138 so as to be movable back and forth. The movable valve portion 146 includes, for example, a valve element (not illustrated) which is displaced under electromagnetic action of the coil 144, and a diaphragm (not illustrated) supporting the peripheral portion of the valve element and connected to the second housing 124. The movable valve portion 146 switches between flowing and non-flowing of pressurized fluid into the third path 126d, depending on whether or not the coil 144 is energized.

When the coil 144 is de-energized, the pilot piston 132 is disposed on the base end side of the piston accommodation space 128, and thus the spool 96 is disposed at the first position. At this moment, pressurized fluid is supplied from the body 12 to the first pressure chamber 134 via the branch channel 110, the main path 126a, and the first path 126b, so that the high pressure is caused in the first pressure chamber 134, and then the pilot piston 132 is kept in the base end position. Moreover, when the coil 144 in the second housing 124 is de-energized, the movable valve portion 146 blocks the communication with the second path 126c and thus blocks the flow of the pressurized fluid into the second path 126c. Part of the pressurized fluid supplied from the branch channel 110 is discharged from the main path 126a to the outside through the discharge path 126e.

When the coil 144 is energized, the movable valve portion 146 that has blocked the communication with the second housing channel 138 is displaced, so that the solenoid valve 100 establishes the communication with the second housing channel 138. As a result, the pressurized fluid is led into the second pressure chamber 136 via the main path 126a, the second path 126c, the second housing channel 138, and the third path 126d. The second pressure chamber 136 into which the pressurized fluid has flowed applies high pressure to the pilot piston 132 to thereby move the pilot piston 132 toward the distal end. As a result, the spool 96 is disposed at the second position by the pilot piston 132 when the coil 144 is energized.

The manual operator space 130 in the first housing 122 extends in the direction of the arrow C and has an opening in an upper part of the first housing 122. A manual operator 148 is disposed inside the manual operator space 130. The manual operator 148 is screw-engaged with a threaded structure of the manual operator space 130 in the first housing 122, and is thereby capable of being displaced in the vertical direction of the first housing 122. That is, a user can change the vertical position of the manual operator 148 by manually operating a head portion 148a exposed at an upper part of the manual operator space 130, to thereby switch between a communication state and a non-communication state between the second path 126c and the third path 126d. Consequently, in the solenoid valve 100, the user can manually switch between the base end position and the distal end position of the pilot piston 132.

The fluid pressure cylinder 10 according to this embodiment is basically configured as above. Next, the operational effects thereof will be described.

The fluid pressure cylinder 10 is offered as a product with the solenoid valve 100 disposed inside the body 12 as described above, and is installed in an installation target by a user. As illustrated in FIG. 1, the body 12 of the fluid pressure cylinder 10 does not have any part protruding significantly from the outer edges of the end plate 50 in the direction of the arrow B or in the direction of the arrow C. That is, the surfaces of the body 12 do not increase in size although the solenoid valve 100 is disposed inside the fluid pressure cylinder 10. This allows the fluid pressure cylinder 10 to be easily installed in an installation target (without changing the design of the installation target, for example) even when the installation target has a small space.

As illustrated in FIGS. 6A and 6B, a joint to which the pressurized fluid supply device 200 is connected is inserted into and secured to the supply port 72 of the fluid pressure cylinder 10. The pressurized fluid supply device 200 supplies pressurized fluid to the supply port 72 of the fluid pressure cylinder 10 at an appropriate supply pressure (supply rate). Moreover, a power connector of a power supply (not illustrated) is connected to the power port 140 of the solenoid valve 100 by the user. This enables the solenoid valve 100 to switch between energization and de-energization of the coil 144 under the control of the circuit board 142.

As described above, the fluid pressure cylinder 10 supplies part of the pressurized fluid flowing into the supply port 72 to the solenoid valve 100 via the supply channel 102, the spool accommodation space 98, and the branch channel 110. When the coil 144 is de-energized, the solenoid valve 100 operates to push the pilot piston 132 toward the base end (to the base end position) using the pressurized fluid supplied from the branch channel 110. This causes the spool 96 connected to the pilot piston 132 to be disposed at the first position.

As illustrated in FIG. 6A, when the spool 96 is disposed at the first position, the supply channel 102 and the rod-side middle path 108a communicate with each other via the spool accommodation space 98. Thus, the pressurized fluid supplied to the supply port 72 flows through the supply channel 102, the spool accommodation space 98, the rod-side middle path 108a, and the rod-side lateral path 108b in this order, and is supplied from the rod-side openings 42a to the rod-side cylinder chambers 42 of the first and second cylinder holes 20a and 20b.

The pressurized fluid supplied to the rod-side cylinder chambers 42 applies pushing force such that the first and second pistons 24a and 24b move toward the base end. That is, the fluid pressure cylinder 10 pushes the first and second pistons 24a and 24b and the first and second piston rods 26a and 26b toward the base end to place the end plate 50 at a retracted position (position adjacent to the body 12).

Here, in a case where the end plate 50 is disposed at a position closer to the distal end side than the retracted position (i.e., in a case where pressurized fluid is in the head-side cylinder chambers 40), pressurized fluid is discharged from the head-side cylinder chambers 40 as the first and second pistons 24a and 24b move toward the base end. When the spool 96 is disposed at the first position, the head-side discharge path 104b and the head-side middle path 106a communicate with each other via the spool accommodation space 98. Thus, the pressurized fluid in the head-side cylinder chambers 40 flows in the head-side longitudinal paths 106c, the head-side lateral path 106b, the head-side middle path 106a, the spool accommodation space 98, the head-side discharge path 104b, the controller port 76, and the merging path 104a. The pressurized fluid is then discharged from the discharge port 74 to the outside (atmosphere).

The opening of the head-side speed controller 76a in the controller port 76 is set by the user as appropriate such that the discharge rate of the pressurized fluid passing through the head-side speed controller 76a is adjusted during discharge. As a result, the flow rate of pressurized fluid discharged from the head-side cylinder chambers 40, in other words, the speed of the first and second pistons 24a and 24b moving toward the base end is adjusted.

On the other hand, when the coil 144 is energized, the solenoid valve 100 operates to push the pilot piston 132 toward the distal end (to the distal end position in the piston accommodation space 128) using the pressurized fluid supplied from the branch channel 110. This causes the spool 96 connected to the pilot piston 132 to be disposed at the second position.

As illustrated in FIG. 6B, when the spool 96 is disposed at the second position, the supply channel 102 and the head-side middle path 106a communicate with each other via the spool accommodation space 98. Thus, the pressurized fluid supplied to the supply port 72 flows through the supply channel 102, the spool accommodation space 98, the head-side middle path 106a, the head-side lateral path 106b, and the head-side longitudinal paths 106c in this order, and is then supplied from the head-side openings 40a to the head-side cylinder chambers 40 of the first and second cylinder holes 20a and 20b.

The pressurized fluid supplied to the head-side cylinder chambers 40 applies pushing force such that the first and second pistons 24a and 24b move toward the distal end. That is, the fluid pressure cylinder 10 pushes the first and second pistons 24a and 24b and the first and second piston rods 26a and 26b toward the distal end to place the end plate 50 at an advanced position where the end plate 50 protrudes the most (position away from the body 12).

Here, in a case where the end plate 50 is disposed at a position closer to the base end side than the advanced position (i.e., in a case where pressurized fluid is in the rod-side cylinder chambers 42), pressurized fluid is discharged from the rod-side cylinder chambers 42 as the first and second pistons 24a and 24b move toward the distal end. When the spool 96 is disposed at the second position, the rod-side discharge path 104c and the rod-side middle path 108a communicate with each other via the spool accommodation space 98. Thus, the pressurized fluid in the rod-side cylinder chambers 42 flows in the rod-side openings 42a, the rod-side lateral path 108b, rod-side middle path 108a, the spool accommodation space 98, the rod-side discharge path 104c, the controller port 78, the merging path 104a, and the discharge port 74. The pressurized fluid is then discharged from the discharge port 74 to the outside (atmosphere).

The opening of the rod-side speed controller 78a in the controller port 78 is set by the user as appropriate such that the discharge rate of the pressurized fluid passing through the rod-side speed controller 78a is adjusted during discharge. As a result, the flow rate of pressurized fluid discharged from the rod-side cylinder chambers 42, in other words, the speed of the first and second pistons 24a and 24b moving toward the distal end is adjusted.

In this manner, the end plate 50 disposed at the distal end of the body 12 of the fluid pressure cylinder 10 can be moved back and forth at a desired speed by operating the solenoid valve 100 while pressurized fluid is supplied to the supply port 72.

The technical scope and the effects that can be understood from the above-described embodiment will now be described below.

The fluid pressure cylinder 10 includes the solenoid valve 100 switching between supply and discharge of pressurized fluid to and from the head-side cylinder chambers 40 or the rod-side cylinder chambers 42. Thus, the solenoid valve 100 is not required to be added separately for actual use of the fluid pressure cylinder 10. Moreover, the solenoid valve 100 is disposed inside the surfaces of the body 12. Thus, the fluid pressure cylinder 10 does not increase in size as an entire system during use, allowing users to, for example, carry out design for installation in a preferred manner. That is, the fluid pressure cylinder 10 can achieve significant space-saving and improved usability during use with a simple structure.

The solenoid valve 100 is disposed between the set (pair) of cylinder holes 20. That is, in the body 12, the solenoid valve 100 is disposed in an extra space (or room) left in a direction in which the pair of cylinder holes 20 are arranged side by side. Thus, although the body 12 includes the solenoid valve 100, the body 12 does not increase in size, and space can be further saved.

The middle block portion 82 is disposed in the middle part of the body 12 in the width direction, the middle block portion being configured to connect the first wall portion (upper wall 84) of the body 12 which lies on the one end side in the thickness direction and the second wall portion (lower wall 86) which lies on the other end side, and the solenoid valve 100 is disposed in the middle block portion 82. In addition, the lightening portions 90 formed by cutting out part of the body 12 are disposed between the middle block portion 82 and the cylinder holes 20. The fluid pressure cylinder 10 includes the solenoid valve 100 in the middle block portion 82 and thus allows pressurized fluid to flow evenly in the pair of cylinder holes 20 under the operation of the solenoid valve 100. Furthermore, the weight of the fluid pressure cylinder 10 can be reduced due to the lightening portions 90 provided around the middle block portion 82.

The middle block portion 82, the first wall portion (upper wall 84), and the second wall portion (lower wall 86) are provided with the channels 92 through which pressurized fluid flows, and the middle block portion 82 is provided with the channel selector 94 configured to switch the channels 92 through which pressurized fluid flows. Thus, the fluid pressure cylinder 10 can easily switch between selective supply of pressurized fluid to the head-side cylinder chambers 40 or the rod-side cylinder chambers 42 and selective discharge of the pressurized fluid from the head-side cylinder chambers 40 or the rod-side cylinder chambers 42.

The channel selector 94 includes the spool 96 configured to be displaced under operation of the solenoid valve 100, and the spool accommodation space 98 in which the spool 96 is movably accommodated and with which the channels 92 communicate. The spool accommodation space 98 is formed in the middle part of the body 12 in the thickness direction. Thus, the fluid pressure cylinder 10 can smoothly switch the channels 92 through which the pressurized fluid flows, based on the movement of the spool 96 by the solenoid valve 100. In particular, since the spool accommodation space 98 is created in the middle part of the body 12 in the thickness direction, the solenoid valve 100 installed in the body 12 does not protrude from the surfaces. This prevents an increase in the size of the body 12.

The channels 92 include the supply channel 102 through which pressurized fluid is supplied into the spool accommodation space 98, the discharge channel 104 through which the pressurized fluid is discharged from the spool accommodation space 98, the head-side communication channel 106 configured to connect the spool accommodation space 98 with the head-side cylinder chambers 40, and the rod-side communication channel 108 configured to connect the spool accommodation space 98 with the rod-side cylinder chambers 42. With this configuration, the fluid pressure cylinder 10 allows the pressurized fluid to flow from the supply channel 102 to the head-side cylinder chambers 40 or the rod-side cylinder chambers 42 and from the head-side cylinder chambers 40 or the rod-side cylinder chambers 42 to the discharge channel 104 via the spool accommodation space 98. In addition, the channels 92 can be appropriately switched in the spool accommodation space 98 based on the movement of the spool 96.

The supply channel 102 communicates with the supply port 72 provided at the first wall portion (upper wall 84). The discharge channel 104 communicates with the discharge port 74 provided at the first wall portion (upper wall 84) and includes the head-side discharge path 104b and the rod-side discharge path 104c between the discharge port 74 and the spool accommodation space 98. The head-side discharge path 104b is configured to communicate with the head-side communication channel 106 via the spool accommodation space 98. The rod-side discharge path 104c is configured to communicate with the rod-side communication channel 108 via the spool accommodation space 98. The head-side speed controller 76a exposed at the upper wall 84 is disposed at an intermediate position in the head-side discharge path 104b, the head-side speed controller being configured to adjust the discharge rate of pressurized fluid. The rod-side speed controller 78a exposed at the upper wall 84 is disposed at an intermediate position in the rod-side discharge path 104c, the rod-side speed controller being configured to adjust the discharge rate of pressurized fluid. The fluid pressure cylinder 10 includes the head-side speed controller 76a and the rod-side speed controller 78a in the discharge channel 104 and thus allows the user to adjust the discharge speed of the pressurized fluid. Thus, the movement speeds of the pistons 24 in the fluid pressure cylinder 10 can be set in a preferred manner.

The port group 70 including the supply port 72, the discharge port 74, and accommodation ports for the head-side speed controller 76a and the rod-side speed controller 78a is created in the first wall portion (upper wall 84), and the detection sensors 62 configured to detect the moving positions of the pistons 24 are disposed at positions adjacent to the port group 70. The middle block portion 82 is disposed at a position overlapping with the port group 70 in the thickness direction and is offset from the centerline O of the body 12 in the width direction toward one of the pair of cylinder holes 20 (first cylinder hole 20a). Since the middle block portion 82 is offset from the centerline O of the body 12 in the width direction toward the first cylinder hole 20a, main structures such as the port group 70 and the detection sensors 62 can be evenly arranged on the upper surface 14 of the body 12 with respect to the centerline O in the width direction. Thus, the surfaces of the body 12 can be symmetrical in shape, and the design for installing the fluid pressure cylinder 10, for example, can be facilitated.

The head-side communication channel 106 includes the head-side middle path 106a extending in the middle block portion 82 in the thickness direction, the head-side lateral path 106b communicating with the head-side middle path 106a and extending in the second wall portion (lower wall 86) in the width direction, and the head-side longitudinal paths 106c communicating with the head-side lateral path 106b in the lower wall 86 at the respective positions overlapping with the pair of cylinder holes 20 and extending in the axial direction of the cylinder holes 20. The rod-side communication channel 108 includes the rod-side middle path 108a extending in the middle block portion 82 in the thickness direction and the rod-side lateral path 108b communicating with the rod-side middle path 108a and extending in the lower wall 86 in the width direction. The fluid pressure cylinder 10 can supply pressurized fluid to the head-side cylinder chambers 40 and discharge the pressurized fluid from the head-side cylinder chambers 40 smoothly using the head-side middle path 106a, the head-side lateral path 106b, and the head-side longitudinal paths 106c. Similarly, the fluid pressure cylinder 10 can supply pressurized fluid to the rod-side cylinder chambers 42 and discharge the pressurized fluid from the rod-side cylinder chambers 42 smoothly using the rod-side middle path 108a and the rod-side lateral path 108b.

The middle block portion 82 includes the solenoid valve accommodation space 80 on the side opposite to the attachment position of the end plate 50, the solenoid valve accommodation space being configured to communicate with the spool accommodation space 98 and to accommodate the solenoid valve 100. The solenoid valve accommodation space 80 is exposed at the first wall portion (upper wall 84). Thus, the solenoid valve 100 is exposed at the solenoid valve accommodation space 80 in the fluid pressure cylinder 10. This enables connection to the power port 140 of the solenoid valve 100 and access to the manual operator 148 of the solenoid valve 100 in a preferred manner.

The channels 92 include the branch channel 110 connecting the spool accommodation space 98 with the solenoid valve accommodation space 80. The branch channel 110 communicates with the supply channel 102 at all times regardless of the position of the spool 96. Thus, the fluid pressure cylinder 10 also allows the pressurized fluid, flowing from the supply port 72 to the spool accommodation space 98, to flow into the branch channel 110.

The solenoid valve 100 is a pilot operated solenoid valve configured to receive the pressurized fluid supplied from the branch channel 110 and move the spool 96 based on the pressurized fluid. Use of the pilot operated solenoid valve allows the fluid pressure cylinder 10 to move the spool 96 in a stable manner while saving electric power for driving the solenoid valve 100.

The present invention is not limited in particular to the above-described embodiment, and various modifications can be made thereto without departing from the scope of the present invention. For example, the number of cylinder tubes 22 in the fluid pressure cylinder 10 is not limited to two (first and second cylinder tubes 22a and 22b) and may be three or more. The channels 92 may be configured appropriately according to the number of cylinder holes 20.

1. A fluid pressure cylinder comprising:
a body having a pair of cylinder holes;
a pair of pistons movably accommodated respectively in the pair of cylinder holes;
a pair of piston rods secured respectively to the pair of pistons; and
an end plate connected to end portions of the pair of piston rods,
wherein:
each of the pistons partitions the corresponding cylinder hole into a head-side cylinder chamber and a rod-side cylinder chamber;
the body includes a solenoid valve configured to switch between supply of pressurized fluid to the head-side cylinder chambers or the rod-side cylinder chambers and discharge of the pressurized fluid from the head-side cylinder chambers or the rod-side cylinder chambers; and
the solenoid valve is disposed inside a surface of the body.

2. The fluid pressure cylinder according to claim 1, wherein the solenoid valve is disposed between the pair of cylinder holes.

3. The fluid pressure cylinder according to claim 1, wherein:
a middle block portion is disposed in a middle part of the body in a width direction, the middle block portion being configured to connect a first wall portion of the body that lies on one end side in a thickness direction of the body and a second wall portion of the body that lies on another end side in the thickness direction, the solenoid valve being installed in the middle block portion; and
lightening portions are formed between the middle block portion and the cylinder holes by cutting out part of the body.

4. The fluid pressure cylinder according to claim 3, wherein:
the middle block portion, the first wall portion, and the second wall portion include therein channels through which the pressurized fluid flows; and
the middle block portion includes a channel selector configured to switch the channels through which the pressurized fluid flows.

5. The fluid pressure cylinder according to claim 4, wherein:
the channel selector includes a spool configured to be displaced under operation of the solenoid valve, and a spool accommodation space in which the spool is movably accommodated and with which the channels communicate; and
the spool accommodation space is formed in a middle part of the body in the thickness direction.

6. The fluid pressure cylinder according to claim 5, wherein:
the channels include:
a supply channel through which the pressurized fluid is supplied into the spool accommodation space;
a discharge channel through which the pressurized fluid is discharged from the spool accommodation space;
a head-side communication channel configured to connect the spool accommodation space with the head-side cylinder chambers; and
a rod-side communication channel configured to connect the spool accommodation space with the rod-side cylinder chambers.

7. The fluid pressure cylinder according to claim 6, wherein:
the supply channel communicates with a supply port provided at the first wall portion;
the discharge channel communicates with a discharge port provided at the first wall portion, and includes a head-side discharge path and a rod-side discharge path between the discharge port and the spool accommodation space, the head-side discharge path being configured to communicate with the head-side communication channel via the spool accommodation space, the rod-side discharge path being configured to communicate with the rod-side communication channel via the spool accommodation space;
a head-side speed controller exposed at the first wall portion is disposed at an intermediate position in the head-side discharge path, the head-side speed controller being configured to adjust a discharge rate of the pressurized fluid; and
a rod-side speed controller exposed at the first wall portion is disposed at an intermediate position in the rod-side discharge path, the rod-side speed controller being configured to adjust the discharge rate of the pressurized fluid.

8. The fluid pressure cylinder according to claim 7, wherein:
a port group including the supply port, the discharge port, and accommodation ports for the head-side speed controller and the rod-side speed controller is formed in the first wall portion, and a detection sensor configured to detect moving positions of the pistons is disposed at a position adjacent to the port group; and
the middle block portion is disposed at a position overlapping with the port group in the thickness direction and is offset from a centerline of the body in the width direction toward one of the pair of cylinder holes.

9. The fluid pressure cylinder according to claim 6, wherein:
the head-side communication channel includes a head-side middle path extending in the middle block portion in the thickness direction, a head-side lateral path communicating with the head-side middle path and extending in the second wall portion in the width direction, and head-side longitudinal paths communicating with the head-side lateral path in the second wall portion at respective positions overlapping with the pair of cylinder holes and extending in an axial direction of the pair of cylinder holes; and
the rod-side communication channel includes a rod-side middle path extending in the middle block portion in the thickness direction and a rod-side lateral path communicating with the rod-side middle path and extending in the second wall portion in the width direction.

10. The fluid pressure cylinder according to claim 6, wherein:
the middle block portion includes a solenoid valve accommodation space on a side opposite to an attachment position of the end plate, the solenoid valve accommodation space being configured to communicate with the spool accommodation space and to accommodate the
solenoid valve; and
the solenoid valve accommodation space is exposed at the first wall portion.

11. The fluid pressure cylinder according to claim 10, wherein:
the channels include a branch channel connecting the spool accommodation space with the solenoid valve accommodation space; and
the branch channel communicates with the supply channel at all times regardless of a position of the spool.

12. The fluid pressure cylinder according to claim 11, wherein the solenoid valve is a pilot operated solenoid valve configured to receive the pressurized fluid supplied from the branch channel and move the spool based on the pressurized fluid.
